(19) United States
(12) Patent Application Publication
(10) Pub. No.: US 2014/0324718 A1
(43) Pub. Date: Oct. 30, 2014

(54) METHOD AND SYSTEM FOR PRIVILEGE MANAGEMENT

(71) Applicant: TENCENT TECHNOLOGY (SHENZHEN) COMPANY LIMITED, Shenzhen City (CN)

(72) Inventors: Ruiqin Lin, Shenzhen City (CN); Zewei Xu, Shenzhen City (CN)

(21) Appl. No.: 14/299,286

(22) Filed: Jun. 9, 2014

Related U.S. Application Data
(63) Continuation of application No. PCT/CN2014/074076, filed on Mar. 26, 2014.

(30) Foreign Application Priority Data
Apr. 26, 2013 (CN) 2013101509283

(51) Int. Cl. G06Q 50/00; G06Q 10/00

(52) U.S. Cl. CPC G06Q 50/01; G06Q 10/00
USPC 705/319

(57) ABSTRACT

In one aspect of the invention, a method for privilege management includes obtaining data information associated with a user identification; configuring a corresponding privilege for the user identification, if the obtained data information satisfies a condition for obtaining a privilege; receiving a trigger request for a service logic according to the corresponding privilege; and clearing the corresponding privilege configured for the user identification according to the received trigger request.

### CROSS-REFERENCE TO RELATED APPLICATION

This application is a continuation application of International Patent Application No. PCT/CN2014/074076, filed on Mar. 26, 2014, which itself claims the priority to Chinese Patent Application No. 201310150928.3, filed on Apr. 26, 2013 in the State Intellectual Property Office of P.R. China, which are hereby incorporated herein in their entireties by reference.

### FIELD OF THE INVENTION

The present invention relates generally to the field of privilege management, and more particular, to method and system for privilege management, and a non-transitory computer-readable medium storing instructions which, when executed by one or more processors, cause the system to perform the method for privilege management.

### BACKGROUND OF THE INVENTION

The background description provided herein is for the purpose of generally presenting the context of the present invention. Work of the presently named inventors, to the extent it is described in this background section, as well as aspects of the description that may not otherwise qualify as prior art at the time of filing, are neither expressly nor impliedly admitted as prior art against the present invention.

A social network service (SNS) community is a network community providing core services of human social communications. This type of communities includes Facebook, Twitter, and other similar services. In the SNS community, based on personal interest, a network user may get acquainted with a network user having similar interest, and interact with each other and participate in an activity of the community.

Each SNS community offers many community activities, and service logic of each community activity requires related development and testing of the community activity. Certain service logics may exist in many community activities. Traditionally, each service logic is developed independently, and similar service logics may be developed separately for different community activities. A user's privilege configuration in the service logic is an example. The user's privilege configuration of each community activity is design to perform different functions in different community activities, often requires the developer of the community activity to repeat the development of the same service logic. Such repeated developments of similar service logics increase the cost of developments.

Therefore, a heretofore unaddressed need exists in the art to address the aforementioned deficiencies and inadequacies.

### SUMMARY OF THE INVENTION

Accordingly, it is desirable to provide a privilege management method and a privilege management system that can be applied in multiple service logics that have similar privilege management requirements such that the repeated similar developments activities can be avoided and the development cost can be reduced.

In one aspect of the present invention, a method for privilege management includes obtaining data information associated with a user identification; configuring a corresponding privilege for the user identification, if the obtained data information satisfies a condition for obtaining a privilege; receiving a trigger request for a service logic according to the corresponding privilege; and clearing the corresponding privilege configured for the user identification according to the received trigger request.

In one embodiment, after the step of clearing the corresponding privilege configured for the user identification according to the received trigger request, the method further includes configuring a corresponding prize voucher according to the trigger request.

In one embodiment, an available number of using the corresponding privilege configured for the user identification is a preset number.

In one embodiment, the step of clearing the corresponding privilege configured for the user identification according to the received trigger request comprises subtracting one from the available number of using the corresponding privilege configured for the user identification according to the trigger request.

In one embodiment, the method further comprises determining whether the available number of using the corresponding privilege has been run out, and if yes, ending the procedure; if not, continuously receiving the trigger request for the service logic according to the corresponding privilege.

In one embodiment, the method further comprises configuring an expiry period of the corresponding privilege for the user identification.

In one embodiment, the method further comprises determining whether the corresponding privilege is in the expiry period, and if yes, receiving the trigger request for the service logic according to the corresponding privilege; if not, clearing the corresponding privilege configured for the user identification.

In another aspect of the present invention, a system for privilege management, comprises an obtaining module, adapted to obtain data information associated with a user identification; a configuring module, adapted to configure a corresponding privilege for the user identification if the data information satisfies a condition for obtaining a privilege; a receiving module, adapted to receive a trigger request for a service logic according to the corresponding privilege; and a deleting module, adapted to clear the corresponding privilege configured for the user identification according to the trigger request.

In one embodiment, the system further comprises an allocating module, adapted to configure a corresponding prize voucher according to the trigger request.

In one embodiment, an available number of using the corresponding privilege configured for the user identification is a preset number.

In one embodiment, the deleting module is further adapted to subtract one from the available number of using the corresponding privilege configured for the user identification according to the trigger request.

In one embodiment, the system further comprises a first determining module, adapted to determine whether the available number of using the corresponding privilege has been run out, wherein if yes, the procedure ends; and if not, the receiving module continuously receives the trigger request for the service logic according to the corresponding privilege.

In one embodiment, the configuring module is further adapted to configure an expiry period of the corresponding privilege.

In one embodiment, the system further comprises a second determining module, adapted to determine whether the corresponding privilege is in the expiry period, wherein if yes, the receiving module is adapted to receive the trigger request for the service logic according to the corresponding privilege; and if not, the deleting module is adapted to clear the corresponding privilege configured for the user identification.

In yet another aspect, the present invention also relates to a non-transitory computer-readable medium storing instructions which, when executed by one or more processors, cause the system to perform the method for privilege management, as disclosed above.

According to the invented method and system for privilege management, whether a condition for obtaining a privilege is satisfied is determined according to data information of a user. The corresponding privilege is configured after the condition is satisfied, and the corresponding privilege is cleared after the privilege is used. The privilege management logic may be applied in many service logics having the same privilege configuration requirement. New service logics may all adopt the privilege management logic. Accordingly, the repeated developments can be avoided and the development cost can be reduced. Moreover, the management of such privileges is flexible, which limits the available number of using the corresponding privilege configured for the user identification, and clears the corresponding privilege after being used, and thus is not permanent. As such, the privilege abuse may be prevented and the security for the SNS community activities is also enhanced.

These and other aspects of the present invention will become apparent from the following description of the preferred embodiment taken in conjunction with the following drawings, although variations and modifications therein may be effected without departing from the spirit and scope of the novel concepts of the invention.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment. The drawings do not limit the present invention to the specific embodiments disclosed and described herein. The drawings are not necessarily to scale, emphasis instead being placed upon clearly illustrating the principles of the invention.

FIG. 1 is a flow chart of a method for privilege management according to one embodiment of the present invention.

FIG. 2 is a flow chart of a method for privilege management according to another embodiment of the present invention.

FIG. 3 is a flow chart of a method for privilege management according to yet another embodiment of the present invention.

FIG. 4 is a structural block diagram of a system for privilege management according to one embodiment of the present invention.

FIG. 5 is a structural block diagram of a system for privilege management according to another embodiment of the present invention.

FIG. 6 is a structural block diagram of a system for privilege management according to yet another embodiment of the present invention.

### DETAILED DESCRIPTION OF THE INVENTION

The following description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements.

The terms used in this specification generally have their ordinary meanings in the art, within the context of the disclosure, and in the specific context where each term is used. Certain terms that are adapted to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, the terms “comprising,” “including,” “having,” “containing,” “involving,” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more operations within a method is executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term “shared”, as used herein, means that some or all code from multiple modules is executed using a single (shared) processor. In addition, some or all code from multiple modules is stored by a single (shared) memory. The term “group”, as used herein, means that some or all code from a single module is executed using a group of processors. In addition, some or all code from a single module is stored using a group of memories.

The systems and methods described herein are implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

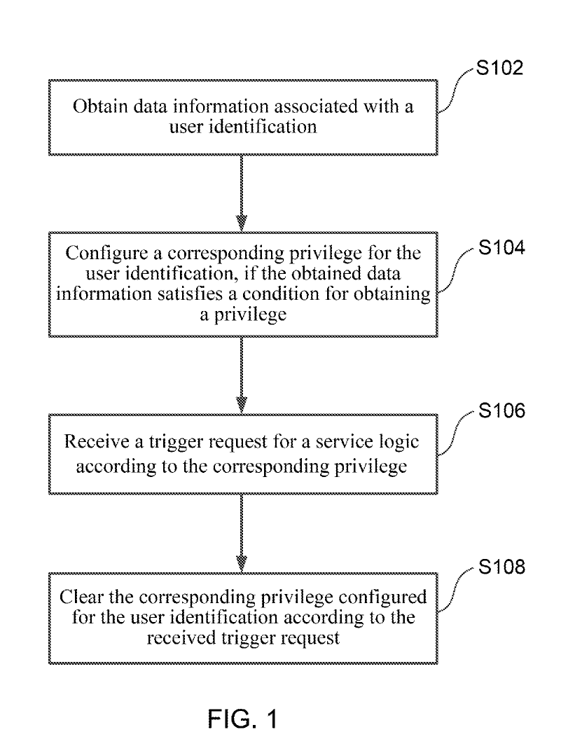

Embodiments of the present invention are illustrated in detail hereinafter with reference to accompanying drawings in FIGS. 1-6. It should be understood that specific embodiments described herein are merely intended to explain the present invention, but not intended to limit the present invention. In accordance with the purposes of this invention, as embodied and broadly described herein, this invention, in certain aspects, relates to method and system for privilege management, and a non-transitory computer-readable medium storing instructions which, when executed by one or more processors, cause the system to perform the method for privilege management.

Referring to FIG. 1, a flow chart of a method for privilege management is shown according to one embodiment of the present invention. The privilege management method may be applied to a public server, adapted to manage a privilege for a user to access or use certain service logics, and is located on the public server, which is convenient for being called by another server, e.g., a WeChat server, requiring using the privilege management function. As shown in FIG. 1, the privilege management method includes the following steps.

At step S102, data information associated with a user identification is obtained.

Specifically, the user identification refers to an identification for distinguishing an identity of a user on the network. The user identification may be, but is not limited to, a registration name and/or registration account of the user. Using user activities (interactions) in an SNS community as an example, a user needs to apply for registration by logging in an SNS server through a browser, or a client terminal. The SNS server receives registration information input by the user, and performs authentication. Once the authentication is passed, the SNS server allocates a registration account and a registration name for the user. The registration account may be an email, an instant messaging account, and the like, provided by the user. The registration name may be a user name in the registration information input by the user. The registration account and the registration name are both unique. The registration information may include, but is not limited to, a user true name, a user profession, an address, contact information, and the like.

The data information associated with the user identification refers to data information related to the user identification. The data information may be different for different service logics. In one embodiment, data generated when the user completes an operation in different service logic is recorded, and the recoded data can be used as the data information. For example, comment information, microblog information, and the like issued by the user are received; and the number of the comment information and the number of the microblog information are counted. The numbers can be used as the data information. Alternatively, a level upgrade request of the user is received; level information after upgrading is recorded. The level information can also be used as the data information.

At step S104, a corresponding privilege for the user identification is configured if the data information satisfies a condition for obtaining a privilege. Specifically, the condition for obtaining a privilege may be set according to different service logics. For example, if the user's level reaches a predetermined level, the user may be granted with the privilege of viewing registration information of another user. Additionally, if the user's level reaches a different level, the user may be granted with the privilege of sweepstakes drawing or receiving prizes. Also, if the user becomes a superuser, the superuser may be granted with the privilege of modifying system software.

If the data information obtained meets the condition for obtaining a privilege, the user with the user identification is given a corresponding privilege. The privilege possessed by the user identification may be denoted by a mark. The mark may be a word, an image, or a combination of a word and an image. For example, if the user has a privilege to user certain service logic, then the mark may be an image defined or self-defined by the user. After the user logs into a server through a browser or a client terminal, the mark may be displayed on an operation interface as an indication of the certain service logic for the user. In certain embodiments, the server being logged in by the user is a server providing the certain service logic.

At step S106, a trigger request for service logic according to the corresponding privilege for the user identification is received. Specifically, after the user logs in the server through the browser or client, a triggering operation may be performed on the service logic corresponding to the privilege on the operation interface. In one embodiment, a button of using the privilege may be displayed on the operation interface, and the server receives a trigger request from the service logic generated by the user pressing the button. In another embodiment, the user may use the privilege to view registration information of another user, or use the privilege to participate in a sweepstakes drawing or receiving prizes. The server being logged in is the server providing the certain service.

At step S108: the corresponding privilege configured for the user identification is cleared according to the trigger request.

In certain embodiment, the server clears the corresponding privilege configured for the user identification after the user uses the corresponding privilege configured for the user identification.

In the privilege management method, if the data information obtained from a user meets a condition for obtaining a privilege, a corresponding privilege is granted (configured) for the user identification. The corresponding privilege is cleared after the corresponding privilege is used by the user. The privilege management logic may be applied in many service logics having the same privilege configuration requirement. New service logics may all adopt the privilege management logic. Accordingly, the repeated developments can be avoided and the development cost can be reduced. Moreover, the management of such privileges is flexible, which limits the available number of using the corresponding privilege configured for the user identification, and clears the corresponding privilege after being used, and thus is not permanent. As such, the privilege abuse may be prevented and the security for the SNS community activities is also enhanced.

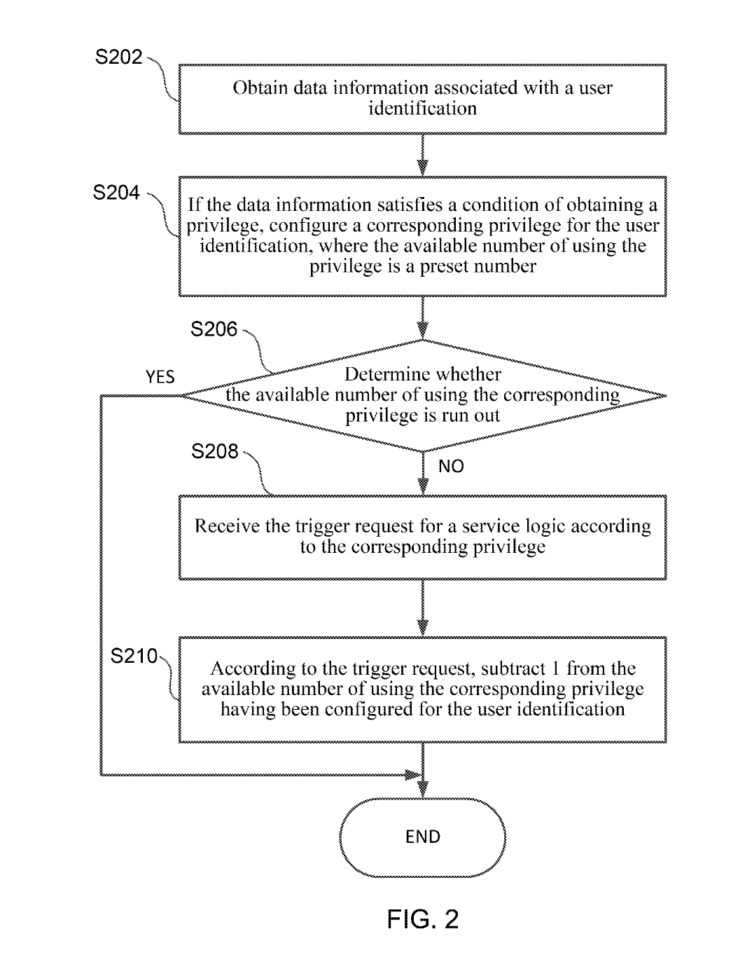

Referring to FIG. 2, a flow chart of a privilege management method is shown according to another embodiment of the invention. The privilege management method shown in FIG. 2 differs from the privilege management method shown in FIG. 1. The number of using the privilege configured in accordance with the method shown in FIG. 2 is a preset number. The privilege management method shown in FIG. 2 includes the following steps.

At step S202: data information associated with a user identification is obtained.

The data information associated with the user identification refers to data information related to the user identification. The data information is different for different service logics. In one embodiment, data generated when the user completes an operation in different service logic is recorded, and the recoded data can be used as the data information. For example, comment information, microblog information, and the like issued by the user are received; and the number of the comment information and the number of the microblog information are counted. The numbers can be used as the data information. Alternatively, a level upgrade request of the user is received; level information after upgrading is recorded. The level information can also be used as the data information.

At step S204, if the data information satisfies a condition for obtaining a privilege, a corresponding privilege for the user identification is configured, where the available number of using the privilege is a preset number. The preset number may be set as required, such as 5 and 10. Specifically, the condition for obtaining a privilege may be set according to different service logics. For example, if the user's level reaches a predetermined level, the user may be given the privilege of viewing registration information of another user. If the user's level reaches a different level, the user may be given the privilege of sweepstakes drawing or receiving prizes. If the user becomes a superuser, the superuser may be given the privilege of modifying system software.

Since the number times of using the corresponding privilege is set, the privilege management becomes more flexible. Certain privilege may be granted to users to participate in the community activities. On the other hands, the issue of unreasonable usage of the privilege caused by permanent privilege configuration is avoided to prevent privilege abuses.

At step S206, whether the available number of using the corresponding privilege is run out is determined. If yes, the procedure is ended; and if not, step S208 is performed.

Specifically, it is determined whether the number of using the privilege has been run out. If the number is run out, a character, an image or the like of prompting “run out” is displayed on the operation interface. If the number has not been run out, the trigger request of the user for the service logic is continuously received according to the corresponding privilege.

In one embodiment, the step S206 of determining whether the available number of using the corresponding privilege has been run out may also be performed after the step S208 of receiving the trigger request for the service logic according to the corresponding service logic.

At step S208: the trigger request for the service logic according to the corresponding privilege is received.

At step S210, according to the trigger request, one (1) is subtracted from the available number of using the corresponding privilege configured for the user identification. Specifically, after the trigger request is generated, that is, when the privilege is used once by the user, correspondingly, it is required to subtract 1 from the available number of using the corresponding privilege, the available number decreases by 1 every time the privilege is used once by the user, and until the total number of using the corresponding privilege reaches the preset number, i.e., the available number of using the corresponding privilege configured for the user identification reaches zero. In this case, the available number of using the corresponding privilege configured for the user identification has been run out.

According to this privilege management method, if the data information from a user meets a condition for obtaining a privilege, a corresponding privilege is configured for the user and an available number of using the corresponding privilege configured for the user identification is also assigned. Every time the corresponding privilege is used, the available number of using the corresponding privilege configured for the user identification is decreased by 1, until the available number of using the corresponding privilege configured for the user identification reaches zero where the available number of using the corresponding privilege is run out. The privilege management logic may be utilized in many service logics having similar privilege configuration requirements. New service logics may also adopt the privilege management logics. Accordingly, the repeated developments can be avoided and the development cost can be reduced. Moreover, the management of such privileges is flexible, which limits the available number of using the corresponding privilege configured for the user identification, and clears the corresponding privilege after being used, and thus is not permanent. As such, the privilege abuse may be prevented and the security for the SNS community activities is also enhanced.

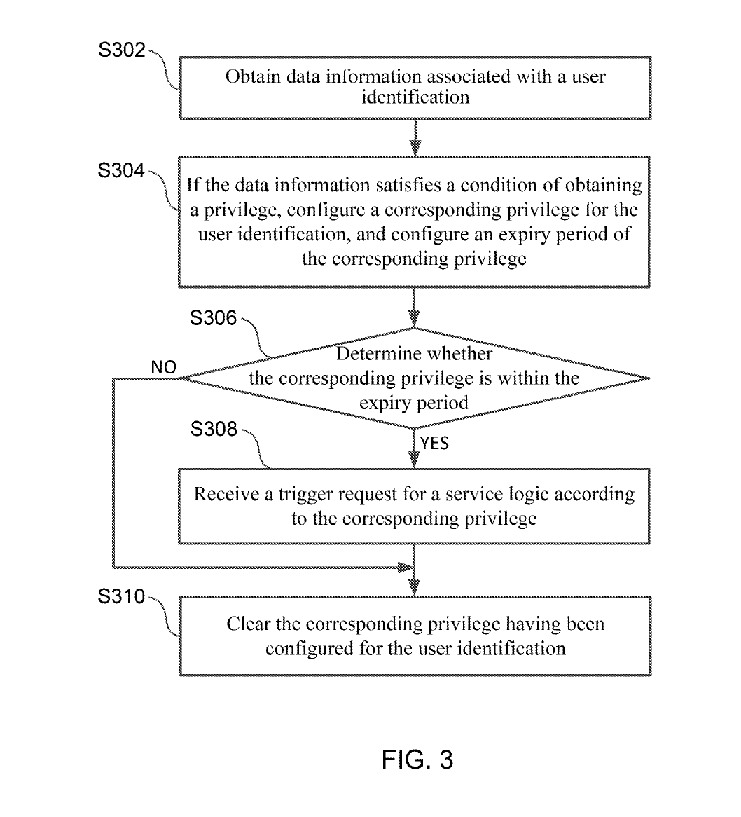

Referring to FIG. 3, a flow chart of a privilege management method according to yet another embodiment is shown. The privilege management method shown in FIG. 3 differs from the privilege management method shown in FIG. 1. The difference between the two embodiments is an expiry period of time for using the privilege is set (configured) in the privilege management method shown in FIG. 3, where the privilege can only be used during the expiry period of time. As shown in FIG. 3, the privilege management method includes the following steps.

At step S302: data information associated with a user identification is obtained.

The data information associated with the user identification refers to data information having correspondence with the user identification. The data information is different for different service logics. In one embodiment, data generated when the user completes an operation in different service logic is recorded, and is used as the data information. For example, comment information, microblog information, and the like issued by the user are received; and the number of the comment information and the number of the microblog information are counted. The numbers can be used as the data information. Alternatively, a level upgrade request of the user is received; level information after upgrading is recorded. The level information can also be used as the data information.

At step S304, if the data information satisfies a condition for obtaining a privilege, a corresponding privilege for the user identification is configured, and an expiry period of the corresponding privilege is also configured. Specifically, the condition for obtaining a privilege may be set according to different service logics. For example, in one embodiment, when the level reaches a predetermined level, a privilege of viewing registration information of another user may be obtained. In another embodiment, when the level reaches a predetermined level, a privilege of performing lucky draw or gaining a prize may be obtained. In addition, when the user is of a superuser identification, a privilege of modifying system software may be obtained. In one embodiment, the user is given a corresponding privilege in a predetermined expiry time period, e.g., 2 days or 7 days. For example, the user can be granted (configured) with a specific end time when the granted privilege expires, the user can use the corresponding privilege any time between the time the privilege is configured and the specific end time.

At step S306: whether the corresponding privilege is within the expiry period is determined. If yes, step S308 is performed; otherwise, step S310 is performed.

Specifically, when it is determined that the corresponding privilege is within the expiry period, prompt information indicating that the privilege has not expired may be displayed on an operation interface. The prompt information may be expressed in a character or image form. When the corresponding privilege is beyond the expiry period, a server clears the corresponding privilege configured for the user identification, and displays prompt information indicating that the privilege has expired on the operation interface. The service for logging in is a service providing a certain service.

At step S308, a trigger request for a service logic according to the corresponding privilege is received, and step S310 is then performed.

At step S310, the corresponding privilege configured for the user identification is cleared.

According to the privilege management method, if the data information obtained from a user with a user identification meets a condition for obtaining a privilege, a corresponding privilege is configured for the user, and a specific end time for the privilege is also configured for the user. After the corresponding privilege is used within the expiry period, the configured corresponding privilege is cleared for the user. The privilege management logic may be utilized in many service logics having similar privilege configuration requirements, and new service logics may also adopt the privilege management logic. Thus, the repeated developments can be avoided and the development cost can be reduced. In addition, according to the privilege management method, the privilege given is only valid during a limited time period and is not permanent, and the corresponding privilege is cleared when the specific end time is reached. In this way, the abuse of privilege may be prevented, and the security of the SNS community activities is also enhanced.

In certain embodiments of the privilege management method, both the expiry period of the privilege and the available number of using the privilege can be configured. Accordingly, through the combination of them, the security of the privilege management may be further improved.

In certain embodiments, the privilege management method may be used in various service logics of community activities, such as lucky draw or receiving prizes in any SNS communities. The specific procedure includes, but is not limited to: obtaining data information associated with a user identification; configuring a corresponding privilege for the user identification if the data information satisfies a condition for obtaining a privilege; receiving a trigger request of performing lucky draw or gaining a prize according to the corresponding privilege; and clearing, according to the trigger request, the privilege of performing lucky draw or gaining a prize which is configured for the user identification, and configuring a corresponding prize voucher according to the trigger request. In one embodiment, the condition for obtaining a privilege may be that the user level reaches a predetermined level. The prize voucher may be a coupon having a certain value, an order number for exchanging a certain object, or the like. Moreover, an expiry period and the available number of using the privilege of performing lucky draw or gaining a prize may be configured.

In certain embodiments, the privilege management method may also be applied in service logic of viewing registration information of another user. The specific procedure includes, but is not limited to, obtaining data information associated with a user identification; configuring a corresponding privilege for the user identification if the data information satisfies a condition for obtaining a privilege; receiving a trigger request of viewing registration information of a user according to the corresponding privilege; and clearing, according to the trigger request, the privilege of viewing registration information that has been configured for the user identification, and returning, according to the trigger request, the viewed registration information of the user. The condition for obtaining a privilege may be that the user level reaches a predetermined level. Moreover, an expiry period and the available number of using the privilege of viewing the registration information may be configured.

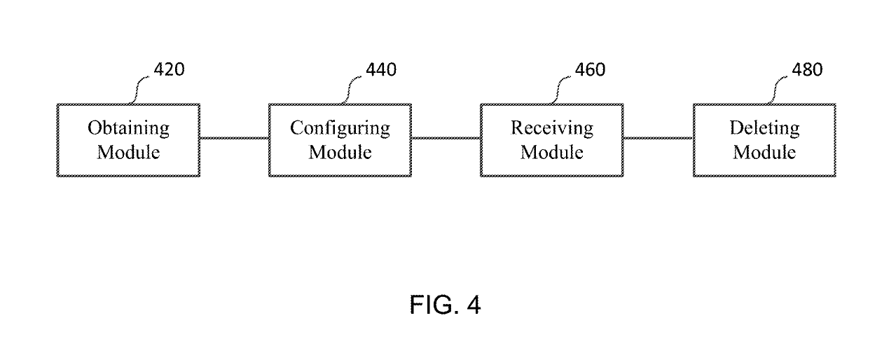

Referring to FIG. 4, a structural block diagram of a privilege management system is shown accosting to one embodiment of the invention. The privilege management system may be run on a public server, which is convenient for being called by another server requiring using the privilege management functions. The privilege management system includes an obtaining module 420, a configuring module 440, a receiving module 460, and a deleting module 480.

The obtaining module 420 is adapted to obtain data information associated with a user identification. Specifically, the user identification refers to an identification for distinguishing an identity of a user on the network. The user identification may be a registration name and/or registration account of the user. Using user interactions (activities) in an SNS community as an example, a user needs to apply for registration by logging in an SNS server through a browser or client terminal. The SNS server receives registration information input by the user, performs authentication, and allocates a registration account and a registration name for the user once the authentication is passed. The registration account may be an email, an instant messaging account, and the like provided by the user. The registration name may be a user name in the registration information input by the user. The registration account and the registration name are both unique. The registration information may include a user true name, a user profession, an address, contact information, and the like.

The data information associated with the user identification refers to data information having correspondence with the user identification. The data information is different for different service logics. In certain embodiments, data generated when the user completes an operation in service logic is recorded, and the data is used as the data information. For example, comment information, microblog information, and the like issued by the user are received; and the number of the comment information and the number of the microblog information are counted. The numbers can be used as the data information. Alternatively, if a level upgrade request of the user is received; and level information after upgrading is recorded. The level information can also be used as the data information.

The configuring module 440 is adapted to configure a corresponding privilege for the user identification if the data information satisfies a condition for obtaining a privilege. Specifically, the condition for obtaining a privilege may be set according to different service logics. For example, in one embodiment, when the level reaches a predetermined level, a privilege of viewing registration information of another user may be obtained. In another embodiment, when the level reaches a predetermined level, a privilege of performing lucky draw or gaining a prize may be obtained. Further, when the user is of a superuser identification, a privilege of modifying system software may be obtained.

Once the data information satisfies the condition for obtaining a privilege, the corresponding privilege is granted for the user identification. In one embodiment, the privilege possessed by the user identification may be denoted by a mark. The mark may be a word, an image, or a combination of a word and an image. For example, if the user has a privilege to user certain service logic, then the mark may be an image defined or self-defined by the user. After the user logs into a server through a browser or a client terminal, the mark may be displayed on an operation interface as an indication of the certain service logic for the user. In certain embodiments, the server being logged in by the user is a server providing the certain service logic.

The receiving module 460 is adapted to receive a trigger request for a service logic according to the corresponding privilege. Specifically, after the user logs in the server through the browser or client terminal, a triggering operation may be performed on the service logic corresponding to the privilege on the operation interface. In one embodiment, a button for triggering operation of using the privilege may be displayed on the operation interface, and the server receives a trigger request for the service logic generated when the user triggers (clicks or activates) the button. For example, the button can be associated with a triggering operation of using the privilege to view registration information of a certain user; or using the privilege to perform lucky draw or gain a prize. The server being logged in is a server providing certain services.

The deleting module 480 is adapted to clear the corresponding privilege configured for the user identification according to the trigger request.

After the user uses the privilege, the server clears the privilege. The server being logged in is a server providing a certain service.

In the privilege management system as disclosed above, whether a condition for obtaining a privilege is satisfied is determined according to data information of a user; the corresponding privilege is configured after the condition is satisfied, and the corresponding privilege is cleared after the privilege is used. The privilege management logic may be applied in many service logics having the same privilege configuration requirement. New service logics may all adopt the privilege management logic. Accordingly, the repeated developments can be avoided and the development cost can be reduced. Moreover, the management of such privileges is flexible, which limits the available number of using the corresponding privilege configured for the user identification, and clears the corresponding privilege after being used, and thus is not permanent. As such, the privilege abuse may be prevented and the security for the SNS community activities is also enhanced.

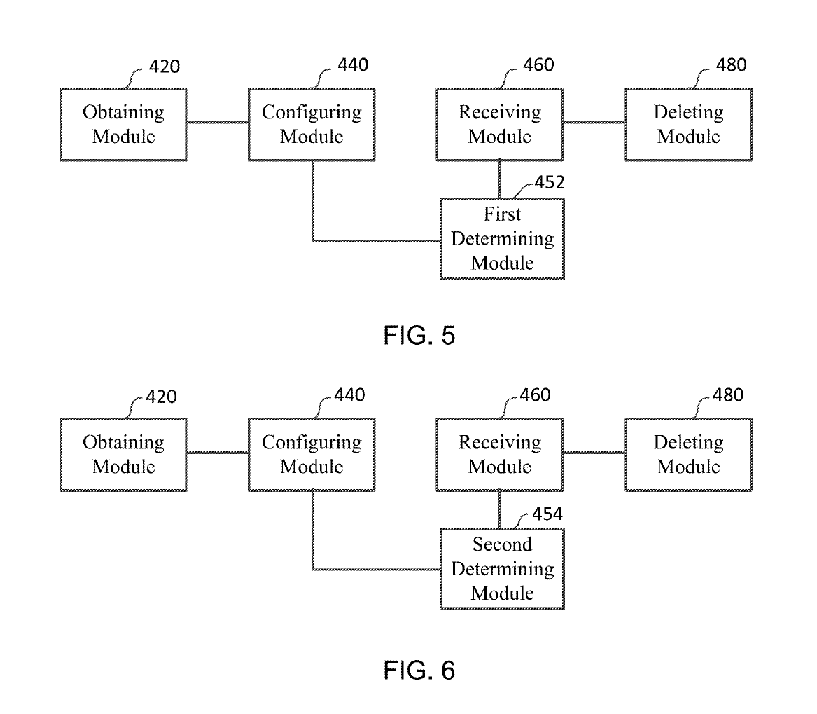

In addition, referring to FIG. 5, a structural block diagram of a privilege management system is shown according to another embodiment of the invention. The privilege management system, in addition to the obtaining module 420, the configuring module 440, the receiving module 460 and the deleting module 480, further includes a first determining module 452.

In this exemplary embodiment, the configuring module 440 is also adapted to configure the available number of using the corresponding privilege configured for the user identification to a preset number.

In certain embodiments, the number of using the corresponding privilege configured for the user identification is the preset number. The preset number may be set to be, e.g., 5, or 10. Setting the number of using the privilege further increases the flexibility of the privilege management. Accordingly, a certain privilege can be granted to the user, and the issue of unreasonable usage of the privilege caused by a permanent privilege configuration is avoided.

The first determining module 452 is adapted to determine whether the available number of using the corresponding privilege has been run out. If yes, the procedure ends; and if not, the receiving module 460 continuously receives a trigger request for the service logic according to the corresponding privilege.

The deleting module 480 is adapted to subtract one (1) from the available number of using the corresponding privilege configured for the user identification according to the trigger request. Specifically, after the trigger request is generated, that is, when the privilege is used once by the user, correspondingly, one is subtracted from the available number of using the corresponding privilege, the available number thus decreases by one every time the privilege is used by the user, and until the total number of use reaches the preset number where the privilege has been run out.

According to in the privilege management system, whether a condition for obtaining a privilege is satisfied is determined according to data information of a user, the corresponding privilege is configured after the condition is satisfied, the available number of using the privilege is also configured, and after the privilege is used once by the user, one is subtracted from the available number of using the privilege. The privilege management logic may be applied in many service logics having the same privilege configuration requirement. New service logics may all adopt the privilege management logic. Accordingly, the repeated developments can be avoided and the development cost can be reduced. Moreover, the management of such privileges is flexible, which limits the available number of using the corresponding privilege configured for the user identification, and clears the corresponding privilege after being used, and thus is not permanent. As such, the privilege abuse may be prevented and the security for the SNS community activities is also enhanced.

Referring to FIG. 6, a structural block diagram of a privilege management system is shown according to one embodiment of the present invention. The privilege management system, in addition to the obtaining module 420, the configuring module 440, the receiving module 460 and the deleting module 480, further includes a second determining module 454.

In this exemplary embodiment, the configuring module 440 is further adapted to configure an expiry period of the corresponding privilege. In certain embodiments, the expiry period of the privilege is configured to be, for example, 2 days or 7 days.

The second determining module 454 is adapted to determine whether the corresponding privilege is within the expiry period. If yes, the receiving module 460 is adapted to receive a trigger request for a service logic according to the corresponding privilege; otherwise, the deleting module 480 is adapted to clear the corresponding privilege configured for the user identification. Specifically, the second determining module 454 determines that the corresponding privilege is within the expiry period, and prompt information indicating that the privilege has not expired may be displayed on an operation interface. The prompt information may be expressed in a character or image form. When the corresponding privilege is beyond the expiry period, a server clears the corresponding privilege configured for the user identification, and displays the prompt information indicating that the privilege has expired on the operation interface. In certain embodiments, the service for logging in is a service providing a certain service.

In certain embodiments, the privilege management system may configure both the expiry period of the privilege and the available number of using the privilege. Through the combination of them, the security of the privilege management may be further improved.

The privilege management system as disclosed above may be applied in service logic for an activity of online lucky draw or gaining of a prize in the SNS community. In one embodiment, the privilege management system further includes an allocating module. Specifically, the obtaining module 420 is adapted to obtain data information associated with a user identification; the configuring module 440 is adapted to configure a corresponding privilege for the user identification if the data information satisfies a condition for obtaining a privilege; the receiving module 460 is adapted to receive a trigger request of performing lucky draw or gaining a prize according to the corresponding privilege; the deleting module 480 is adapted to clear, according to the trigger request, the privilege of performing lucky draw or gaining a prize that is configured for the user identification; and the allocating module is adapted to configure a corresponding prize voucher according to the trigger request. In certain embodiments, the condition for obtaining a privilege may be that the user level reaches a predetermined level. The prize voucher may be a coupon having a certain value, an order number for exchanging a certain object, or the like. Moreover, both of an expiry period and the available number of using the privilege of performing lucky draw or gaining a prize may be configured.

In certain embodiments, the privilege management system may also be applied in a service logic of viewing registration information of another user. In certain embodiments, the privilege management system further includes a returning module. Specifically, the obtaining module 420 is adapted to obtain data information associated with a user identification; the configuring module 440 is adapted to: if the data information satisfies a condition for obtaining a privilege, configure a corresponding privilege for the user identification; the receiving module 460 is adapted to receive a trigger request of viewing registration information of a user according to the corresponding privilege; the deleting module 480 is adapted to clear, according to the trigger request, the privilege of viewing registration information that has been configured for the user identification; and the returning module is adapted to return, according to the trigger request, the viewed registration information of the user. In addition, the condition for obtaining a privilege may be that the user level reaches a predetermined level. Moreover, an expiry period and the available number of using the privilege of viewing the registration information may be configured.

It should be noted that all or a part of the steps according to the embodiments of the present invention is implemented by hardware or a program instructing relevant hardware. Yet another aspect of the invention provides a non-transitory computer readable storage medium/memory which stores computer executable instructions or program codes. The computer executable instructions or program codes enable a computer or a similar computing system to complete various operations in the above disclosed method for privilege management. The storage medium/memory may include, but is not limited to, high-speed random access medium/memory such as DRAM, SRAM, DDR RAM or other random access solid state memory devices, and non-volatile memory such as one or more magnetic disk storage devices, optical disk storage devices, flash memory devices, or other non-volatile solid state storage devices.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for privilege management, comprising:
obtaining data information associated with a user identification;
configuring a corresponding privilege for the user identification, if the obtained data information satisfies a condition for obtaining a privilege;
receiving a trigger request for a service logic according to the corresponding privilege; and
clearing the corresponding privilege configured for the user identification according to the received trigger request.

2. The method according to claim 1, after the step of clearing the corresponding privilege configured for the user identification according to the received trigger request, further comprising:
configuring a corresponding prize voucher according to the trigger request.

3. The method according to claim 1, wherein an available number of using the corresponding privilege configured for the user identification is a preset number.

4. The method according to claim 3, wherein the step of clearing the corresponding privilege configured for the user identification according to the received trigger request comprises:
subtracting one from the available number of using the corresponding privilege configured for the user identification according to the trigger request.

5. The method according to claim 4, further comprising:
determining whether the available number of using the corresponding privilege has been run out, and if yes, ending the procedure; if not, continuously receiving the trigger request for the service logic according to the corresponding privilege.

6. The method according to claim 1, further comprising:
configuring an expiry period of the corresponding privilege for the user identification.

7. The method according to claim 6, further comprising:
determining whether the corresponding privilege is in the expiry period, and if yes, receiving the trigger request for the service logic according to the corresponding privilege; if not, clearing the corresponding privilege configured for the user identification.

8. A system for privilege management, comprising:
an obtaining module, adapted to obtain data information associated with a user identification;
a configuring module, adapted to configure a corresponding privilege for the user identification if the data information satisfies a condition for obtaining a privilege;
a receiving module, adapted to receive a trigger request for a service logic according to the corresponding privilege; and
a deleting module, adapted to clear the corresponding privilege configured for the user identification according to the trigger request.

9. The system according to claim 8, further comprising:
an allocating module, adapted to configure a corresponding prize voucher according to the trigger request.

10. The system according to claim 8, wherein an available number of using the corresponding privilege configured for the user identification is a preset number; and
wherein the deleting module is further adapted to subtract one from the available number of using the corresponding privilege configured for the user identification according to the trigger request.

11. The system according to claim 10, further comprising:
a first determining module, adapted to determine whether the available number of using the corresponding privilege has been run out, wherein if yes, the procedure ends; and if not, the receiving module continuously receives the trigger request for the service logic according to the corresponding privilege.

12. The system according to claim 8, wherein the configuring module is further adapted to configure an expiry period of the corresponding privilege.

13. The system according to claim 12, further comprising:
a second determining module, adapted to determine whether the corresponding privilege is in the expiry period, wherein if yes, the receiving module is adapted to receive the trigger request for the service logic according to the corresponding privilege; and if not, the deleting module is adapted to clear the corresponding privilege configured for the user identification.

14. A non-transitory computer-readable medium storing instructions which, when executed by one or more processors, cause a system to perform a method for privilege management, the method comprising:
obtaining data information associated with a user identification;
configuring a corresponding privilege for the user identification, if the obtained data information satisfies a condition for obtaining a privilege;
receiving a trigger request for a service logic according to the corresponding privilege; and
clearing the corresponding privilege configured for the user identification according to the received trigger request.

15. The non-transitory computer-readable medium according to claim 14, wherein, after the step of clearing the corresponding privilege configured for the user identification according to the received trigger request, the method further comprises:
configuring a corresponding prize voucher according to the trigger request.

16. The non-transitory computer-readable medium according to claim 14, wherein an available number of using the corresponding privilege configured for the user identification is a preset number.

17. The non-transitory computer-readable medium according to claim 16, wherein the step of clearing the corresponding privilege configured for the user identification according to the received trigger request comprises:
subtracting one from the available number of using the corresponding privilege configured for the user identification according to the trigger request.

18. The non-transitory computer-readable medium according to claim 17, further comprising:
determining whether the available number of using the corresponding privilege has been run out, and if yes, ending the procedure; if not, continuously receiving the trigger request for the service logic according to the corresponding privilege.

19. The non-transitory computer-readable medium according to claim 14, wherein the method further comprises:
configuring an expiry period of the corresponding privilege for the user identification.

20. The non-transitory computer-readable medium according to claim 19, wherein the method further comprises:
determining whether the corresponding privilege is in the expiry period, and if yes, receiving the trigger request for the service logic according to the corresponding privilege; if not, clearing the corresponding privilege configured for the user identification.
